(19) United States
(12) Patent Application Publication
(10) Pub. No.: US 2007/0228840 A1
(43) Pub. Date: Oct. 4, 2007

(54) Switchable on-die decoupling cell

(76) Inventors: Omer Vikinski, Haifa (IL); Nachum Shamir, Haifa (IL)

Correspondence Address: RYDER IP LAW;C/O INTELLEVATE, P. O. BOX 52050, MINNEAPOLIS, MN, 55402, US

(21) Appl. No.: 11/396,304

(22) Filed: Mar. 31, 2006

(51) Int. Cl. B60L 1/00; B23K 11/24

(52) U.S. Cl. 307/112

(57) ABSTRACT

In general, in one aspect, the disclosure describes a switchable on-die decoupling cell. The switchable on-die decoupling cell includes a decoupling device and a device damping element. The device damping element can serve as a digital. The damping element may be switched off in a low power mode to preserve power. Other embodiments are disclosed herein.

### BACKGROUND

Integrated circuits (ICs) are typically powered from one or more supply voltages provided by external high-efficiency voltage regulator modules located near the IC package. The power is provided through power planes, pins, vias, and bumps to the integrated circuit die. Voltage droops may happen when rapid current transients occur due to variable chip activity. Power delivery decoupling elements are used to reduce these voltage droops. The decoupling elements may include motherboard and package discrete capacitors and on-die decoupling cells (that act as capacitors).

The effective serial inductance of package capacitors along with the package inductive parasitics make the package capacitors un-effective as decoupling elements in frequencies above 100 MHz. As modern ICs invoke significant current transients in frequencies that exceed 100 MHz, on-die decoupling elements are needed to maintain the resulting voltage oscillations within a reasonable range. The effective serial resistance of the decoupling elements serves to damp power delivery network voltage oscillations in the frequency range between the package and on-die decoupling capacitors operation. Current package capacitor technology may not supply significant effective serial resistance to damp oscillations caused by the package-die resonance that may occur in the range of 100 MHz-1 GHz. Proper on-die decoupling effective serial resistance needs to damp the package-die resonance in order to prevent a high peak in the power delivery network impedance profile (high magnitude of voltage oscillations due to chip current load transients with near-by frequency content).

FIG. 1 illustrates an on-chip decoupling cell 100 used for power supply decoupling. The decoupling cell 100 includes a decoupling device 110 (accumulation-mode PMOS capacitor) in series with a resistive damping element 120 (polysilicon resistor formed on the die). The decoupling device 110 may be coupled to ground 130 and the resistive damping element 120 may be coupled to a power supply 140. The decoupling device 110 may utilize its gate capacitance to decouple the power supply 140 to ground 130. The resistive damping element 120 may serve to damp the expected LC resonance between the package capacitors parasitic inductance and the on-die decoupling.

### BRIEF DESCRIPTION OF THE DRAWINGS

The features and advantages of the various embodiments will become apparent from the following detailed description in which:

FIG. 1 illustrates an example of a current on-chip decoupling cell;

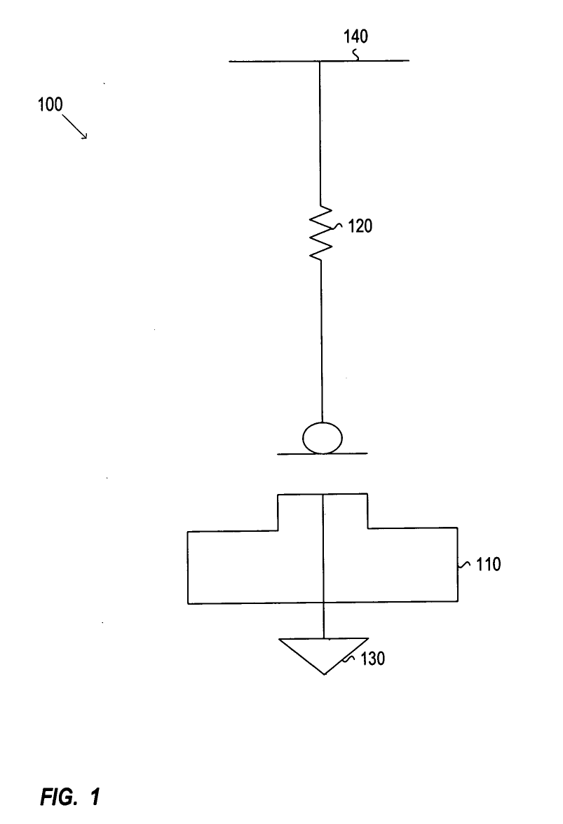

FIG. 2 illustrates an example simplified equivalent electrical scheme of power being provided to an integrated circuit (IC), according to one embodiment;

FIG. 3 illustrates an example switchable on-chip decoupling cell, according to one embodiment;

FIG. 4 illustrates an example switchable on-chip decoupling cell, according to one embodiment;

FIG. 5 illustrates an example power delivery impedance profile over the frequency domain, according to one embodiment; and

FIG. 6 illustrates an example functional diagram system utilizing a switchable decoupling device, according to one embodiment.

### DETAILED DESCRIPTION

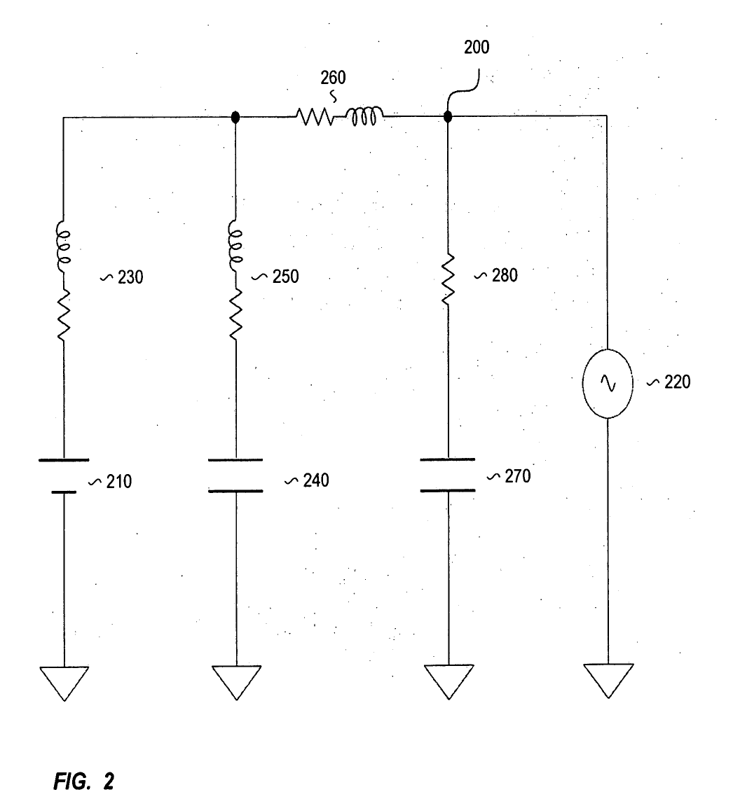

FIG. 2 illustrates an example simplified equivalent electrical scheme of power being provided to an integrated circuit (IC). The power is provided to the IC (a power supply node 200) via a voltage regulator 210. The IC die consumes a variable amount of current 220 based on the instantaneous activity of the IC. Rapid current transients may occur due to variable IC current consumption and cause power voltage oscillations. The oscillations of the power supply level may result in significant degradation of IC performance, higher reliability hazards, and even system failures. Power delivery decoupling may be utilized to reduce the magnitude of the voltage oscillations. The voltage regulator 210 and its effective output impedance 230 may cease to stabilize the voltage level for current load transients whose spectral content is higher then a certain level (e.g., 100 KHz). Motherboard and package decoupling elements 240 may help reduce power voltage oscillations for a limited frequency range (e.g., up to 100 MHz) due to their internal serial impedance 250 and the parasitic path impedance 260 to the die.

On die decoupling may be performed in parallel to the die current load 220. On-die decoupling devices (e.g., capacitor) 270 may be used to stabilize the power and reduce the voltage oscillations at higher frequencies (e.g., above 100 MHz). A damping element (e.g., resistor) 280 may provide the needed damping to reduce the expected LC resonance created between the package parasitic inductive path 260 and the die decoupling 270.

Modern microprocessors may control the core power supply and thus may significantly reduce the core leakage in low power modes (e.g., sleep, idle, wait). However, some accessory power supplies, such as the I/O power supply and analog circuitry devoted power supplies, do not have variable voltage level control and therefore have the same voltage level in both active and idle states. Accordingly, the decoupling device leakage (e.g., gate leakage) for these accessory power supplies may contribute a significant portion of the power consumption during lower power modes. Reducing this power consumption (e.g., gate leakage) during low power modes is desired.

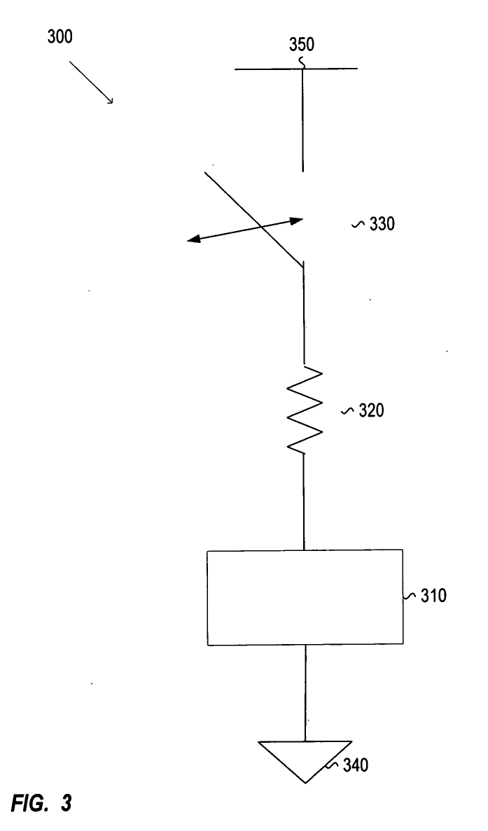

FIG. 3 illustrates an example switchable on-chip decoupling cell 300 used for power supply decoupling (e.g., core power, I/O power, analog power). The decoupling cell 300 includes a decoupling device 310 in series with a damping element 320 and a switching device 330. The decoupling device 310 may decouple a power supply 350 to ground 340. The damping element 320 may serve to damp the expected LC resonance between the package capacitors parasitic inductance and the on-die decoupling. The switching device 330 may open and disable (turn off) the decoupling cell 300 when the IC is in a low power mode and may enable (turn on) the decoupling cell when the IC is in an operational mode (e.g., non-low power mode).

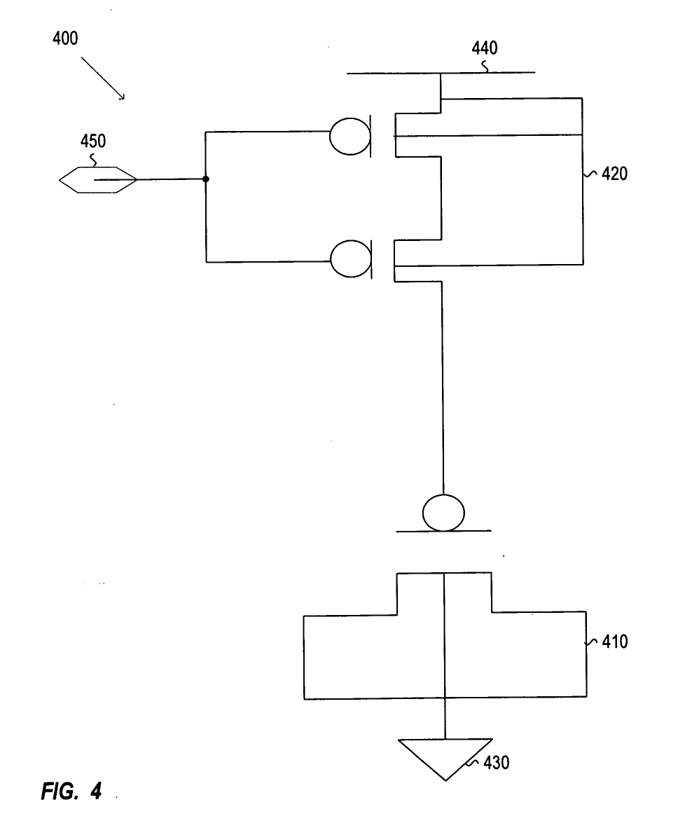

FIG. 4 illustrates an example embodiment of the switchable on-chip decoupling cell 400. The decoupling cell 400 includes a decoupling device (e.g., capacitor) 410 in series with an active device damping element 420 between ground 430 and a power supply 440. The decoupling device 410 may be an accumulation mode PMOS capacitor or any other on die capacitor device. The active device damping element 420 may be one or more transistors that can act as a digital switch as well as provide the effective resistance needed for power voltage oscillation attenuation. A stack of devices (a pair of PMOS transistors as illustrated) may be utilized as larger widths may increase the accuracy of the damping resistance value (the device Rds) and increase process/voltage/temperature stability.

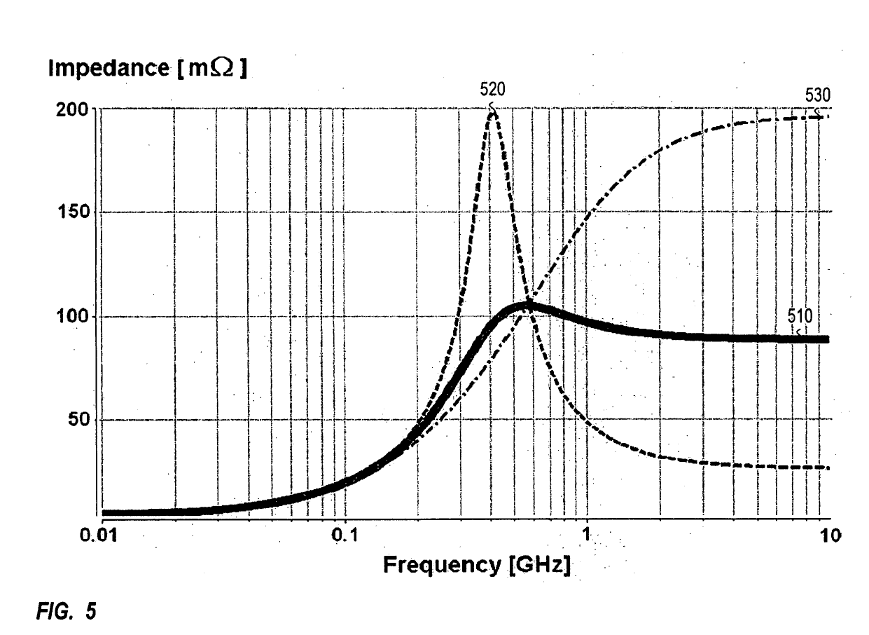

FIG. 5 illustrates an example power delivery impedance profile over the frequency domain. A preferred damped impedance profile 510 includes the impedance increasing over a certain range of frequencies due to the package capacitor effective inductive path. The preferred damped impedance profile 510 then levels off at a value set by the on-die damping element. The preferred damping profile 510 may be substantially achieved if a damping element value is tuned for the particular IC. If the damping element has too low resistance an under damped impedance profile 520 may result. The under damped impedance profile 520 may display large impedance resonance due to package inductance and on-die decoupling under-damped LC interaction. If the damping element has too high resistance an over-damped impedance profile 530 may result in high impedance and large voltage oscillations in the high frequency range.

Resistive damping elements may be susceptible to reliability issues and may be process/voltage/temperature (PVT) sensitive. If the value of the resistive element varies greatly it may affect the power delivery impedance profile and offset its preferred tuning 510 to an under-damped state 520 or an over-damped state 530. Utilizing an active device damping element (e.g., 420 of FIG. 4) may better maintain the damping value tuned for the specific IC and reduce offsets (under and over damping) to the preferred damping profile 510.

The device damping element 420 may act as an open switch turning off the decoupling cell 400 when the IC is in a low power mode and may act as a closed switch turning on the decoupling cell when the IC is in an operational mode (e.g., non-sleep). The decoupling cell 400 may include an input 450 to receive an enable signal. The input 450 may be to the device damping element 420 to control the operation thereof. The input 450 may be to a gate(s) of the transistor(s) in the active device damping element 420. The enable signal may be utilized to activate or deactivate the device damping element 420 (e.g., open or close the switch) and accordingly deactivate or activate the decoupling cell 400.

If the damping element 420 is activated (e.g., closed switch) it will provide the effective resistance needed and the decoupling device 410 will serve as an effective on-die capacitor and will consume gate leakage power. If the damping element 420 is deactivated (e.g., open switch) it will act as an open circuit and the decoupling device 410 will stop consuming gate leakage power. The enable signal may activate the damping element 420 when the IC is in normal operational mode and may deactivate the damping element 420 when the IC is in low power or sleep mode.

The enable signal may be a signal that is already generated by the IC (e.g., by the CPU) for use by other functions of the IC. For example, a signal may be activated when the IC is in operational mode or a signal may be activated when the IC is in a sleep mode or a reduced power mode. ICs have inherent detailed definition, settings and control of various modes from which the decoupling enable signal may be derived.

The on/off switching of the decoupling cell 400 may consume significant current. However, if the decoupling cells 400 are to be turned off for more then some amount of time it may be beneficial to turn-off the on-die capacitors to reduce the leakage power consumption. For devices powered by battery the reduced power consumption can increase battery life.

The decoupling cell 400 may be used in any type of IC to reduce power consumption. The decoupling cell 400 may be best utilized in mobile ICs that require batteries to provide the power as reducing the power consumption will save the battery life. Mobile ICs may be used in any number of mobile devices including but not limited to laptop computes, cell phones, personal digital assistants (PDAs), gaming consoles, and portable entertainment devices. The mobile devices may include one or more mobile processors to operate the device. The processors may include on die memory, may utilize off die memory, or some combination thereof. The mobile devices may include an antenna for communications and a battery for power.

Using the decoupling cell 400 in mobile ICs may allow significant reduction of power consumption as the device damping element 420 may serve as an easy-to-use local switch for cutting-off the decoupling device gate leakage in low power and sleep modes. Moreover, the decoupling cell 400 may provide better power delivery network stability against switching noise oscillations. Both of those advantages are extremely important for mobile platform chips, which value power saving features, and utilize low voltage supplies where large swing power supply oscillations can significantly degrade the circuit performance. As a result of the power effective design, it is possible to significantly increase the amount of on-die decoupling capacitance and provide, within the same average power envelope, a more robust and stable power delivery design.

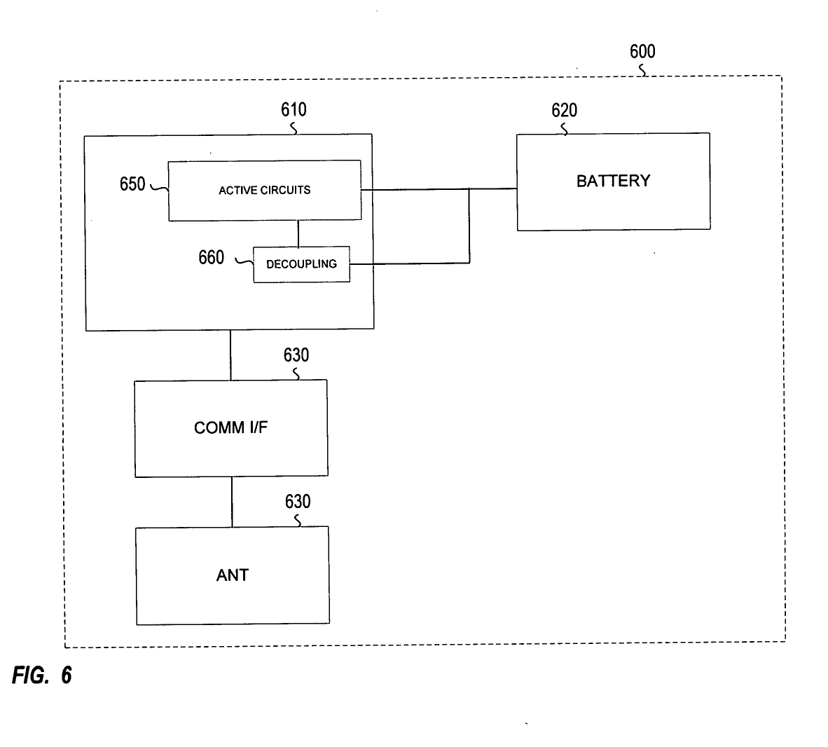

FIG. 6 illustrates an example functional diagram of a system 600 utilizing switchable decoupling cells (e.g., 300, 400). The system includes a processor 610 to perform operations, a battery 620 to provide power to the processor 610, a communications interface 630 and an antenna 640 to provide wireless communications. The processor may include active circuitry 650 and decoupling circuitry 660 (including switchable decoupling cells). The power from the battery may be applied to the active circuitry and the decoupling circuitry in parallel so that the decoupling circuitry can decouple the power. A signal (e.g., an operational mode signal) may be provided from the active circuitry to the decoupling circuitry to control the switching of the decoupling circuitry.

Although various embodiments have been described and illustrated, it will be apparent that various changes and modifications may be made. Reference to “one embodiment” or “an embodiment” means that a particular feature, structure or characteristic described in connection with the embodiment is included in at least one embodiment. Thus, the appearances of the phrase “in one embodiment” or “in an embodiment” appearing in various places throughout the specification are not necessarily all referring to the same embodiment.

Different implementations may feature different combinations of hardware, firmware, and/or software. It may be possible to implement, for example, some or all components of various embodiments in software and/or firmware as well as hardware, as known in the art. Embodiments may be implemented in numerous types of hardware, software and firmware known in the art, for example, integrated circuits, including ASICs and other types known in the art, printed circuit broads, components, etc.

The various embodiments are intended to be protected broadly within the spirit and scope of the appended claims.

What is claimed:

1. An switchable on-die decoupling cell, comprising
a decoupling device; and
a damping element coupled to the decoupling device, wherein the damping element can serve as a digital switch.

2. The cell of claim 1, wherein the decoupling device is a capacitor.

3. The cell of claim 1, wherein the decoupling device is a transistor capacitor.

4. The cell of claim 1, wherein the damping element includes at least one transistor.

5. The cell of claim 1, wherein the damping element is controllable by an enable signal.

6. The cell of claim 1, wherein the damping element is to be switched off during low power modes to inhibit leakage power consumption.

7. An integrated circuit comprising
a damping element coupled to a power source, wherein the damping element is capable of being turned on and off based on operational status of the integrated circuit; and
a decoupling device in series with the damping element.

8. The integrated circuit of claim 7, wherein the decoupling device is an accumulation mode transistor.

9. The integrated circuit of claim 7, wherein the damping element includes a serial stack of transistors.

10. The integrated circuit of claim 7, wherein the damping element is to provide an effective serial resistance to inhibit package-die resonance.

11. The integrated circuit of claim 7, wherein the damping element is to be turned off when the integrated circuit is in low power or sleep modes.

12. The integrated circuit of claim 11, wherein the decoupling device leakage power is to be inhibited when the damping element is turned off.

13. The integrated circuit of claim 7, wherein the damping element and capacitor are in parallel to a subset of active components on the integrated circuit that are to receive power from the power source.

14. The integrated circuit of claim 7, further comprising active components to provide a signal to the damping element to control the on and off status of the damping element.

15. The integrated circuit of claim 14, wherein the signal indicates the mode of the integrated circuit.

16. The integrated circuit of claim 7, wherein
the decoupling device is a capacitor; and
the damping element includes at least one transistor.

17. A system comprising
a processor die including active circuitry and decoupling circuitry, wherein the decoupling circuitry is used to decouple power provided to at least some subset of the active circuitry, wherein the decoupling circuitry is in parallel to the active circuitry, and wherein the decoupling circuitry includes
a damping element coupled to a power source, wherein the damping element can act as a digital switch, and wherein the damping element is capable of acting as a switch based on operational power mode status of the wireless device; and
a decoupling device in series with the damping element and coupled to ground; and
an antenna for communications.

18. The system of claim 17, further comprising a battery to provide power to the processor die.

19. The system of claim 18, wherein the damping element is to be turned off when the system is in a low power mode.

20. The system of claim 17, wherein the active circuitry is to provide an enable signal to the damping element to control operation thereof.
